(19) United States
(12) Patent Application Publication
(10) Pub. No.: US 2009/0148484 A1
(43) Pub. Date: Jun. 11, 2009

(54) STABLY-DISPERSING COMPOSITE OF METAL NANOPARTICLE AND INORGANIC CLAY AND METHOD FOR PRODUCING THE SAME

(75) Inventors: Jiang-Jen Lin, Taipei (TW); Chun-Yu Yang, Taipei (TW); Chin-Cheng Chou, Taipei (TW); Hong-Lin Su, Taipei (TW); Ta-Jen Hung, Taipei (TW)

Correspondence Address: PAI PATENT & TRADEMARK LAW FIRM, 1001 FOURTH AVENUE, SUITE 3200, SEATTLE, WA, 98154, US

(73) Assignee: NATIONAL TAIWAN UNIVERSITY, Taipei (TW)

(21) Appl. No.: 12/253,037

(22) Filed: Oct. 16, 2008

(30) Foreign Application Priority Data
Dec. 7, 2007 (TW) 096146931
Apr. 21, 2008 (TW) 097114515

(51) Int. Cl. A01N 25/08; B01J 19/12; B01J 19/10; A01P 1/00; A01N 59/16

(52) U.S. Cl. 424/409; 204/157.4; 204/157.42; 424/618

(57) ABSTRACT

A stably-dispersed composite of metal nanoparticles and inorganic clay and a method for producing the composite, in which interlayered charges of the clay are replaced with the metal ions, which are then reduced to metal particles by a reducing agent. The metal particles will not aggregate together and can be stably uniformly dispersed with particle sizes smaller than conventional metal nanoparticles, and therefore have better antibiotic effect, catalytic ability and other advantages. Antibacterials in a solvent containing 0.01 wt % or more of the metal nanoparticles and inorganic clay are prepared and confirmed to be effective.

### BACKGROUND OF THE INVENTION

1. Field of the Invention

The present invention relates to a stably-dispersing composite of metal nanoparticles and inorganic clays and a method for producing the same, in which the inorganic layered clays serve as carriers for the spherical metal particles. By means of the present invention, a stable and homogeneous dispersion of the metal nanoparticles is prepared without organic dispersant compounds and can be further concentrated into high solid content or dried to obtain a powder product. The solid composite is still dispersible into aqueous solution. The product can be applied in chemical catalysis or as an antibacterial agent.

2. Related Prior Arts

Ag nanoparticles (AgNP) are known to have good antibiotic effect and can destroy more than 600 kinds of bacteria, i.e., over ten times antibiotic ability than chlorine. Even though the solution of Ag nanoparticles is diluted in a very low concentration, effects for inhibiting bacteria such as E. coli, staphylococcus aureus, salmonella and pseudomonas aeruginosa, can still reach 99.99%. When some bacteria are destroyed, the silver ions can be isolated from the dead bacteria and continue to destroy live bacteria until all bacteria are destroyed. In other words, Ag nanoparticles are effective for a long period of time against bacterial activities. Silver is less toxic or nontoxic to most of normal biological functions. Some formulated Ag nanoparticles are used for pharmaceutical purposes. U.S. FDA also allows the related products to be applied to merchandise and mass produced. Some references have reported treatments with Ag nanoparticles in acne, AIDS, anti-allergy, appendicitis, arthritis, anticancer, diabetes, etc. By means of nanotechnology and new synthetic methods, activity of the Ag nanoparticles can be enhanced, surface area thereof increased, and thus antibacterial effect thereof can be about 200 times than silver.

One of the known processes for preparing nanoparticles is to decompose solid objects of bulk phase into smaller particles by high-energy Laser. Another process is to vaporize metal of solid phase into metal gas phase or vapor which is then condensed as metal nanoparticles. Organic solvents can also be used to prepare Ag nanoparticles through a redox reaction. However, such processes are tedious, complicated, energy consuming, instrument dependent and expensive. Furthermore, the concentration of Ag⁺ ions has to be minimized and controlled under one part per million during the preparation, otherwise, the Ag nanoparticles would aggregate into larger sizes, thus reducing the surface area and therefore lowering the efficacy. In addition, conventional organic solvents and surfactants used in the process may reduce the effectiveness of Ag nanoparticles due to the organics/Ag interaction, which reduces the Ag particle surface area, and may have adverse side effects on the environment. These disadvantages in need to be understood and overcome.

In order to stabilize the metal nanoparticles for long-term stability and to prevent them from aggregating into larger sizes, an organic dispersing or protecting agent is generally added during the preparation of the metal nanoparticles. Functions of the dispersants include:

### (1) Electrostatic Repulsion

When organic dispersants are adsorbed onto the same charged surfaces of inorganic particles, Coulomb's electrostatic force will prevent the particles from aggregation. If anions on the surfaces are replaced with neutral ions, the surface charges will decrease and the particles will aggregate due to van der Waal force. In addition, high concentration or ionic strength of the prepared nanoparticle solutions often encounter the problem of lower stability, which can be overcome by using a dispersant with increased dielectric strength or electric double layers for improved stability.

### (2) Steric Hindrance or Barrier

When organic molecules (serving as protectors) are adsorbed on surfaces of metal particles and prevent aggregation of the particles, steric hindrance to particle collision in rendering stability is achieved. Common protectors include: water-soluble polymers (for example, polyvinylpyrolidone (PVP), polyvinylalcohol (PVA), polymethylvinylether, polyacrylic acid (PAA), etc.), surfactants, ligands and chelating agents.

To solve the aggregation problems that are often encountered by the conventional processes, layered structure of inorganic clay is selected in the present invention as the dispersant or protector for the nanosize metal particles, and a redox reaction is performed for preparing a complex of metal nanoparticles and inorganic clay in a stable aqueous solution.

### SUMMARY OF THE INVENTION

The main objective of the present invention is to provide a stably-dispersed composite of metal nanoparticles and inorganic clays and a method for producing the same, which is stable for long-term storage, at high concentration or even in paste/powder form, easily dispersed and effective at highly diluted concentration.

One other object of the present invention is to provide an antibacterial composite of AgNP and clay, so that the AgNP can be blocked outside the cells from destroying the cells.

Another object of the present invention is to provide a method for producing the antibacterial composite of AgNP and clay without using an organic solvent or surfactant.

A further object of the present invention is to provide an antibacterial, which is suitable for applications in various fields of biology, medicine, chemistry, chemical engineering, materials science. An example is an antibacterial for treating scalds and burns.

In the present invention, layered clay having an aspect ratio (width/thickness ratios) of about 100-1,000 is provided as steric barriers to disperse spherical Ag nanoparticles having an aspect ratio of larger than one. Accordingly, the Ag nanoparticles will not aggregate nor precipitate, as shown in FIG. 1. In addition, the clay having special ionic valences which can ultimately be swollen in water facilitates the fine dispersion of the particles or gel forms in a stable manner.

The composite of metal nanoparticles and inorganic clay comprises metal particles and inorganic layered clays, wherein the inorganic layered clays have an aspect ratio of 10-100,000 and serve as an inorganic dispersant or carrier in the amount of 1:100-100:1 weight ratio to the metal particles, preferably 1:30-30:1, whereby the metal particles are capable of being dispersed on a nanoscale into metal nanoparticles in aqueous solution.

The metal particles preferably have a spherical structure, for example, Au, Ag, Cu and Fe. The inorganic layered clay preferably has an aspect ratio of 100-1,000, for example, bentonite, laponite, montmorillonite, synthetic mica, kaolin, talc, attapulgite clay, vermiculite and double hydroxide (LDH). The inorganic layered clay preferably has a structure with a ratio of Si-tetrahedron:Al-octahedron of 1.5: 1-2.5:1 as smectite natural clay. The inorganic layered clay preferably has a cation exchange capacity (CEC) of 0.1-5.0 mequiv/g. The ratio of the ionic equivalent of the metal particles to the cation exchange equivalent of the inorganic layered clay is preferably 0.1-200.

The composite of metal nanoparticles and inorganic clay of this invention can be used as an antibacterial to inhibit growth of Gram positive bacteria, Gram negative bacteria or fungi, for example, staphylococcus aureus, streptococcus pyogenes, pseudomonas aeruginosa, salmonella, E. coli, acinetobacter baumannii and multiple drug resistant staphylococcus aureus. The composite of metal nanoparticles and inorganic clay can be in a powder form or any other suitable forms. To be used as an antibacterial, a therapeutic dosage of the composite of metal nanoparticles and inorganic clay can be mixed with a solvent (for example, water) or a carrier other than the inorganic layered clay. The antibacterial composite of metal nanoparticles and inorganic clay preferably has a solid content of 0.01 wt % or higher. The antibacterial preferably has a solid content 0.05-100 wt % when used to inhibit Gram positive bacteria, or a solid content 0.01-100 wt % when used to inhibit Gram negative bacteria or multiple drug resistant staphylococcus aureus.

In this invention, the method for producing a stably-dispersed composite of metal nanoparticles and inorganic clay comprises at least one step: mixing a metal ionic compound, inorganic layered clay and a reducing agent in water to perform a reductive reaction, wherein the inorganic layered clay has an aspect ratio of 10-100,000 and serves as a dispersant or protector of the metal, so that the metal ionic compound is reduced to metal particles dispersed on a nanoscale.

The reducing agent aforementioned can be methanol, ethanol, propanol, butanol, formaldehyde, ethylene glycol, propylene glycol, butylene glycol, glycerin, poly(vinyl alcohol), poly(ethylene glycol), PPG (polypropylene glycol), dodecanol or sodium borohydride (NaBH₄). The reduction reaction is preferably performed at 25-150° C. for 0.01-20 hours, and/or lighting with a xenon lamp.

After reductive reaction, the product can be further dried so as to obtain a powder product. The reducing reaction is preferably carried out with sonic blending.

### BRIEF DESCRIPTION OF THE DRAWINGS

FIG. 1 shows the dispersion of the spherical Ag nanoparticles by the layered clay according to the present invention;

FIG. 2 shows different behaviors of the AgNP on the cell surfaces with or without clay;

FIGS. 3-7 show the SEM micrograms of the powder product of Examples 5, 18, 16, 19 and 23;

FIG. 8 shows the average diameters of the powder product of Examples 1-15;

FIGS. 9 and 10 respectively show the effects of the AgNP/SWN composite and the AgNP/NSP composite in inhibiting the growth of Gram positive bacteria in the LB solid media;

FIGS. 11 and 12 respectively show the effects of the AgNP/SWN composite and the AgNP/NSP composite in inhibiting the growth of Gram negative bacteria in the LB solid media;

FIGS. 13 and 14 respectively show the effects of the AgNP/SWN composite and the AgNP/NSP composite in inhibiting the growth of multiple drug resistant staphylococcus aureus in the LB solid media;

FIGS. 15 and 16 respectively show the effects of the AgNP/SWN composite in inhibiting the growth of bacteria in the LB liquid media;

FIGS. 17 and 18 respectively show the effects of the AgNP/NSP composite in inhibiting the growth of bacteria in the LB liquid media;

FIGS. 19 and 20 respectively show the effects of the AgNP/NSP composite in inhibiting spore germination of fungi in the PDB media and the agar media containing no nutrients;

FIG. 21 shows the effects of the AgNP/SWN composite with different AgNP/SWN ratios in inhibiting the growth of bacteria.

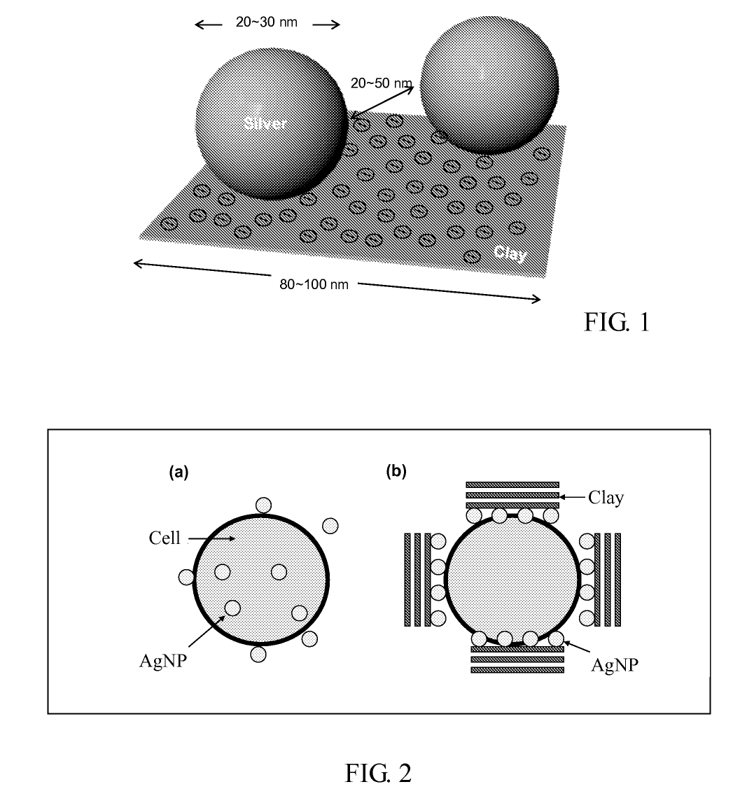

### DETAILED DESCRIPTION OF THE PREFERRED EMBODIMENTS

In the preferred embodiments (Examples) of the present invention, the layered silicate smectite clay having a structure with a ratio of Si-tetrahedron to Al-octahedron of 1.5:1-2.5:1 is used as carriers. The interlayered cations are replaced with Ag⁺ ions, and negative charges are adsorbed on surfaces of the cay. By means of chemical reduction, Ag⁰ atoms then aggregated into nanoscale silver particles will be fixed on the surfaces of the clay, and nanoparticles of silver were separated by the presence of layers of clay in preventing the Ag⁰ particle attraction and aggregation. The clay serves as steric barriers for nanoparticle aggregation and stabilizes the nanosize particles in solution and in powder form.

The antibacterial mechanism of the present invention includes the AgNP and the inorganic clay which serves as carriers of the AgNP and creates steric barriers, so that the AgNP can not enter into the cells and thus destroy the cells. Referring to FIG. 2, diagram (a) shows that the AgNP can directly enter into the cells; and diagram (b) shows that the AgNP are adsorbed by negative surface charges of the clay and thus can not enter into the cells to destroy cells.

Materials used in the preferred embodiments (Examples) of the present invention include:
1. Bentonite: layered silicate clay having cationic exchange capacity (CEC)=0.67 mequiv/g.
2. Silver nitrate (AgNO₃): used for exchanging or replacing Na⁺ between layers of the clays to be reduced to Ag nanoparticles (silver sulfate is also suitable).
3. Sodium borohydride (NaBH₄): a strong reducing agent (superhydride and lithium aluminum hydride are also suitable).
4. Methanol: a weak organic reducing agent capable of slowly reducing silver ions to silver nanoparticles at 30-150° C. (ethanol, ethylene glycol and formaldehyde are suitable for this invention).
5. Glycol (C₂H₄(OH)₂) and formaldehyde: weak organic reducing agents capable of slowly reducing silver ions to silver nanoparticles at 30-150° C.
6. Silver sulfadiazine: product of Sinphar company with trade name “Silvazine” having a concentration of silver=2.6 mM equivalent to 0.5 wt % of AgNP/SWN of this invention.
7. Nanosilicate platelet (NSP): available by exfoliating Na⁺-type montmorillonite (Na⁺-MMT); described in: U.S. Pat. No. 7,125,916, U.S. Pat. No. 7,094,815, and U.S. Pat. No. 7,022,299 or Publication Nos.: US 2006-0287413-A1 and US 2006-0063876A1.
8. Microorganism:
   (1) Staphylococcus aureus (71, 431, 10781), streptococcus pyogenes Rob 193-2, pseudomonas aeruginosa, salmonella (4650, 4653) and E. coli (Escherichia coli): isolated from wild colonies and provided by Dr. Lin Chun-Hung of Animal Technology Institute Taiwan;
   (2) Acinetobacter baumannii: provided by Dr. Huang Chieh-Chen of National Chung Hsing University, Department of Life Sciences, Taiwan;
   (3) Multiple drug resistant staphylococcus aureus: ten colonies, provided by Dr. Huang Fang-liang of Taichung Veterans General Hospital, Taiwan;
   (4) Fungi: obtained from falling dusts, and identified as penicillium, trichoderma HA, fusarium, cladosporium and aspergillus.
9. Preparation of the standard suspensions of bacteria

The suspensions of bacteria cultured overnight were added into a fresh Luria-Bertani (LB) liquid media at a volume ratio of 1/100 for culturing for about three hours. Absorbance (OD₆₀₀) of the suspensions of bacteria after culturing were determined with a spectrophotometer, and the suspensions having OD₆₀₀ values ranging between 0.4-0.6 were selected as the standard suspensions of bacteria.
10. Preparation of the suspension of fungi spores

The colonies were planted on the potato dextrose agar (PDA) solid media at 28° C. for three days and the spores in the media were washed with 0.08% of Tween 80 (ICI Americas, Inc.) into tubes. The spores were dispersed by means of oscillation and then counted with a blood cell counter. The suspension of the spores was then diluted to 10⁵ spores/ml, and mixed with the potato dextrose broth (PDB) liquid media at a ratio of 1:1 to obtain the suspension of the spores for testing (5×10⁴ spores/ml).

In the present invention, preferred natural and synthetic clay include:
1. Synthetic fluorine mica: mica, product of CO—OP Chemical Co. (Japan), code number SOMASIF ME-100, with cationic exchange capacity (CEC)=1.20 mequiv/g.
2. Layered silicate clay: Laponite, product of The FAR EASTERN TRADING Co., LTD., with cationic exchange capacity (CEC)=0.69 mequiv/g.
3. Synthetic layered double hydroxide: [M^{II}₁₋ₓM^{III}ₓ(OH)₂]ᵢₙₜᵣₐ [Aⁿ⁻.nH₂O]ᵢₙₜₑᵣ, M^{II}: Mg, Ni, Cu and Zn, M^{III}: Al, Cr, Fe, V and Ga, Aⁿ⁻: CO₃²⁻ and NO₃⁻ (clay 5), with ionic exchange capacity in the range of 2.0-4.0 mequiv./g.

Detailed procedures of the preferred embodiments are described in the following Examples. Examples 1-16 apply methanol as reducing agent for preparing the Ag nanoparticles, wherein Example 16 further uses a xenon lamp for lighting and enhancing the process. Examples 17-19 apply NaBH₄ as the strong reducing agent for preparing the Ag nanoparticles, wherein Example 19 further uses a xenon lamp for lighting.

### Example 1

A bentonite (clay 1; CEC=0.67 mequiv/g) in water (1.0 wt %) and a AgNO₃ solution (1.0 wt %) were separately prepared in a glass flask. The water solution AgNO_{3(aq)} (1.0 wt %, 0.68 g) was slowly added into the clay solution (30 g, 1.0 wt %) to give a Ag⁺/CEC ratio of 0.2. Ions between layers of the clay, Na⁺, were replaced with Ag⁺ and the solution became creamy color. In the next step, methanol (MeOH, 6-8 mL) was added into the solution with mechanical agitation. After heating in a water bath at 70-80° C., the solution gradually changed its color as the reductive reaction of Ag ions with methanol progressed. After 2-3 hours, the color of the solution became ruby. The product (Ag-clay 1 solution) was obtained.

### Examples 2-15

The procedures of Example 1 were repeated, but dosages of AgNO_{3(aq)} (1.0 wt %) was increased to increase the Ag⁺/CEC ratio to 0.4, 0.6, 0.8, 1.0, 1.5, 2.0, 3.0, 5.0, 8.0, 10, 20, 30, 35 and 200, respectively. The dosage of methanol (MeOH) was also proportionally increased. The products were obtained.

### Example 16

The procedures of Example 5 were repeated, but the solution was further exposed under a xenon lamp while the reductive reaction was performed in a water bath.

### Example 17

A clay 1 solution (1.0 wt %) and a AgNO₃ solution (1.0 wt %) were separately prepared. Then AgNO_{3(aq)} (1.0 wt %, 0.68 g) was slowly added into the clay 1 solution (30 g, 1.0 wt %) to give a Ag⁺/CEC ratio of 0.2. Ions between layers of the clay, Na⁺, were replaced with Ag⁺ and the solution became creamy color. Next, NaBH₄ powders (0.0075 g) were added into the solution in several batches, and the solution immediately became dark yellow-green color. The product was obtained.

### Example 18

The procedures of Example 17 were repeated, but the Ag⁺/CEC ratio was increased to 1.0. The product was obtained.

### Example 19

The procedures of Example 18 were repeated, but the solution was exposed under the light of a xenon lamp when the reductive reaction was performed in a water bath.

### Examples 20-22

The procedures of Example 1 are repeated, but the initial concentrations of SWN and AgNO₃ are changed to 5 wt %, and the ratios of Ag⁺/CEC are respectively changed to 0.2/1.0 (Example 20), 1.0/1.0 (Example 21) and 2.0/1.0 (Example 22), respectively. For Examples 20-21, the temperature of the water bath is 50° C.

### Example 23

The procedures of Example 5 are repeated, but the reduction of step (b) was carried out by means of sonic blending.

### Example 24

### Step (a): Replacement of Na⁺ by Ag⁺

The NSP solution (1.0 wt %) and the AgNO₃ solution (1.0 wt %) were first prepared. Then the AgNO_{3(aq)} solution (3.5160 g) was added into the NSP solution (30 g) to give a ratio of Ag⁺/CEC of 1.0/1.0 and Na⁺ between layers of clay are replaced with Ag⁺. The solution became creamy color.

### Step (b): Reduction of Ag⁺ by Ethylene Glycol

To the solution obtained in step (a), sufficient amount of ethylene glycol (EG, about 0.1-5 mL) was added and the solution remained creamy color. Accompanied with sonic blending, the solution was heated in a water bath at 40-80° C. and a different color appeared. After oscillation, the product AgNP/NSP was obtained.

### Analysis of the Product

The product samples (Ag-clay 1 solutions, 1 ml for each) of the above Examples are dropped on glass substrates (1×1 cm²), and then dried in an oven at about 80° C. for 2 hours. Then, the substrates are plated with carbon for the SEM observation and analysis.

### 1. Uniformity of the Dispersion

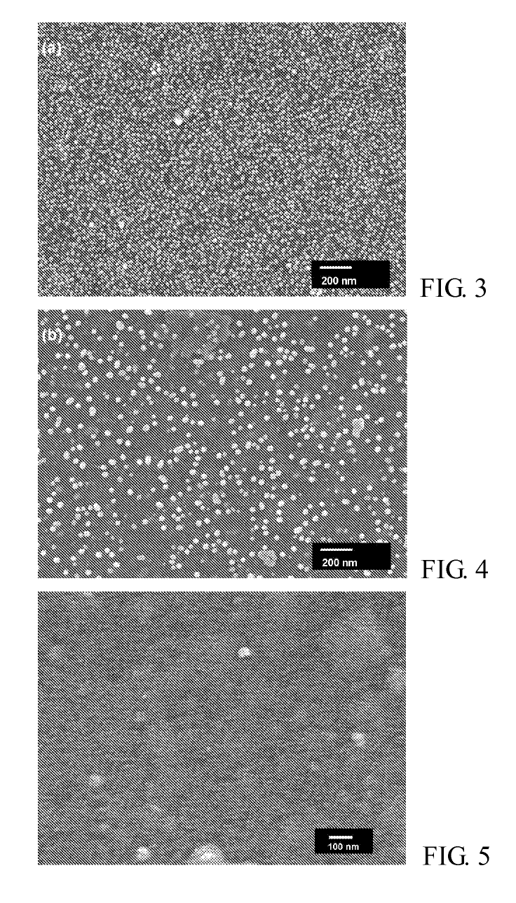

FIGS. 3 and 4 show the SEM pictures of the powder products of Examples 5 and 18. As shown in the figures, both composites of Ag nanoparticles and inorganic clay prepared from the reduction of methanol and NaBH₄ agents exhibited good dispersibility and uniformity, particularly for the composites prepared from the methanol reduction.

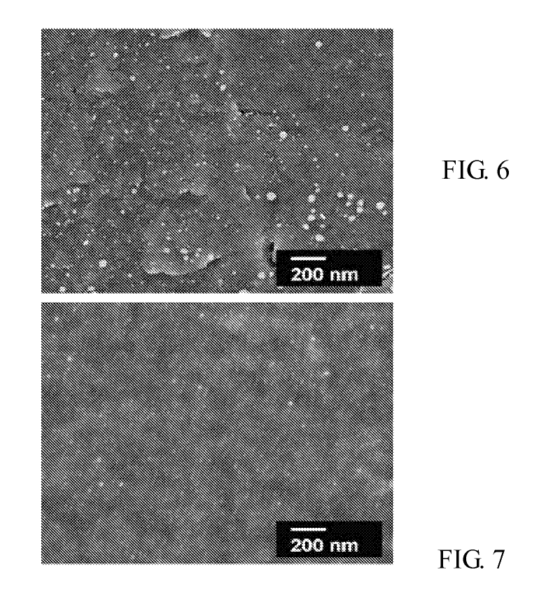

FIGS. 5 and 6 show the SEM pictures of the powder products of Examples 16 and 19. Compared with FIGS. 3 and 4, the Ag nanoparticles prepared with lighting of the xenon lamp are apparently smaller. The reason is that more energy is provided to enhance motions of molecules, which interfere with particle aggregation.

For the traditional processes using organic solvents, the products were found to be easily aggregated after drying. Even though the product was prepared in the form of solution, aggregation occurred after drying in an oven or atmosphere.

Additionally, the product of the present invention can be stably attached to the glass substrates as the clay provided a good adsorption. That is, the solution containing the product of the present invention is suitable for coating or spraying since it can be easily dispersed on glass.

### 2. Analysis of Diameters

Table 1 lists average diameters of the powder products of Examples 1-19, wherein the composite of Ag nanoparticles and inorganic clay prepared with methanol have about half of the diameters of those prepared with NaBH₄. Since the Ag nanoparticles of the present invention are much smaller and have larger surface area than those traditionally prepared, and therefore their antibacterial ability and catalytic efficiency are enhanced.

The reason why the Ag nanoparticles prepared with methanol are smaller than those prepared with NaBH₄ is that methanol is a mild reducing agent, hence, the reduction of Ag⁺ ions into Ag nanoparticles progressed slowly and in a homogeneous manner. In contrast, the reducing agent, NaBH₄, may react rapidly and generate the aggregated Ag nanoparticles of larger diameters. Nevertheless, as both reactions similarly occurred in the presence of layers of the clays, sizes of the Ag nanoparticles of the present invention are controlled.

TABLE 1

| | | | | Interlayered | Average diameter (nm) | | |
|---|---|---|---|---|---|---|---|
| Examples | Ag⁺/CEC | Reducer | Xenon lamp | distance (Å) | Dₙ | D_{w} | D_{w}/Dₙ |
| 1 | 0.2 | methanol | No | 13.8 | 15.0 | 17.7 | 1.18 |
| 2 | 0.4 | methanol | No | 13.8 | 14.9 | 16.9 | 1.13 |
| 3 | 0.6 | methanol | No | 13.9 | 20.1 | 24.1 | 1.20 |
| 4 | 0.8 | methanol | No | 13.8 | 22.4 | 27.1 | 1.21 |
| 5 | 1.0 | methanol | No | 13.9 | 25.9 | 30.1 | 1.16 |
| 6 | 1.5 | methanol | No | 13.7 | 29.6 | 37.6 | 1.14 |
| 7 | 2.0 | methanol | No | 13.2 | 41.6 | 49.9 | 1.20 |
| 8 | 3.0 | methanol | No | 14.6 | 49.1 | 70.1 | 1.43 |
| 9 | 5.0 | methanol | No | 15.8 | 55.7 | 83.2 | 1.49 |
| 10 | 8.0 | methanol | No | 15.9 | 56.3 | 88.4 | 1.57 |
| 11 | 10 | methanol | No | none | 60.7 | 92.1 | 1.54 |
| 12 | 20 | methanol | No | none | 65.2 | 101 | 1.55 |
| 13 | 30 | methanol | No | none | 71.6 | 115 | 1.61 |
| 14 | 35 | methanol | No | none | 83.4 | 125 | 1.51 |
| 15 | 200 | methanol | No | none | — | — | — |
| 16 | 1.0 | methanol | Yes | 13.2 | 9.8 | 10.7 | 1.09 |
| 17 | 0.2 | NaBH₄ | No | 13.8 | 26 | 39 | 1.5 |
| 18 | 1.0 | NaBH₄ | No | 13.7 | 45.7 | 59.3 | 1.3 |
| 19 | 1.0 | NaBH₄ | Yes | 13.8 | 17.7 | 42.5 | 2.40 |

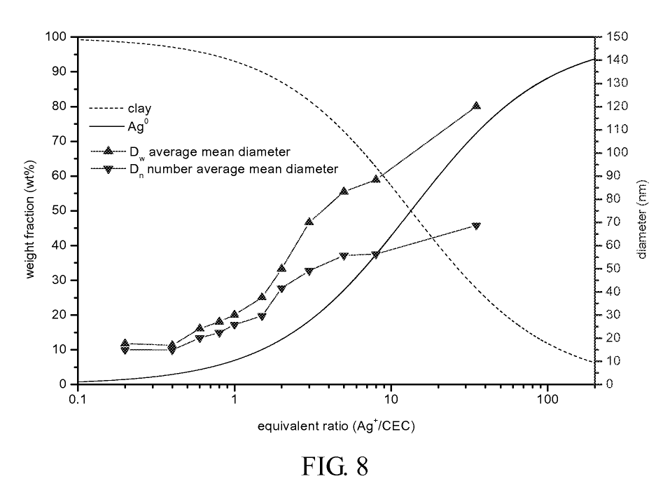

FIG. 8 shows the average diameters of the powder products of Examples 1-15, in which the average diameters of the particles increased with Ag⁺/CEC ratios. Particularly, even when the Ag⁺/CEC ratio (the relative ratio of silver nitrate/clay) reaches 35, the average diameter of the Ag nanoparticles in inorganic clay is only 125 nm. That is, only a small portion of clay is required in the method of the present invention to serve as a carrier for obtaining the uniformly dispersing Ag particles. Further, as solutions of Ag nanoparticles in high concentrations can be obtained in a small-scale experiment, the yield of the present method is high.

TABLE 2

| | | Initial | | | |
|---|---|---|---|---|---|
| | | concen- | Initial | | |
| | | tration | concentration | | Reducing |
| Examples | Clay | of clay | of AgNO₃ | Ag⁺/CEC | agent |
| 20 | SWN | 5 wt % | 5 wt % | 0.2/1.0 | MeOH |
| 21 | SWN | 5 wt % | 5 wt % | 1.0/1.0 | MeOH |
| 22 | SWN | 5 wt % | 5 wt % | 2.0/1.0 | MeOH |
| 23 | SWN | 1 wt % | 1 wt % | 1.0/1.0 | MeOH |
| 18 | SWN | 1 wt % | 1 wt % | 1.0/1.0 | NaBH₄ |
| 24 | NSP | 1 wt % | 1 wt % | 1.0/1.0 | ethylene |
| | | | | | glycol |

To verify the effects of the present invention in inhibiting bacteria, the AgNP/SWN and AgNP/NSP composites obtained in Examples 23 and 24 were adjusted to different concentrations to compare with the solutions of SWN and NSP of 0.5 wt %. Results of the tests are as follows:

### A. Inhibition of Growth of Bacteria in Solid Media

The solutions of AgNP/NSP (or AgNP/SWN) in different ratios were added to LB media before solidification and then to obtain 100 mm LB solid media of different concentrations. The standard suspensions of bacteria (each 10 μl) were spread on the AgNP/NSP (or AgNP/SWN) LB solid media of different concentrations with sterilized glass beads to culture at 37° C. for 16 hours. The numbers of colonies were determined by dividing the plate into 8 or 16 areas wherein one area was selected to count the colonies thereon. The total number of colonies was obtained by multiplying the number of colonies on the selected area with the number of the areas. Results were as follows:

### 1. Gram Positive Bacteria

1.1 AgNP/SWN (Staphylococcus Aureus 71, 431, 10781, Streptococcus pyogenes)

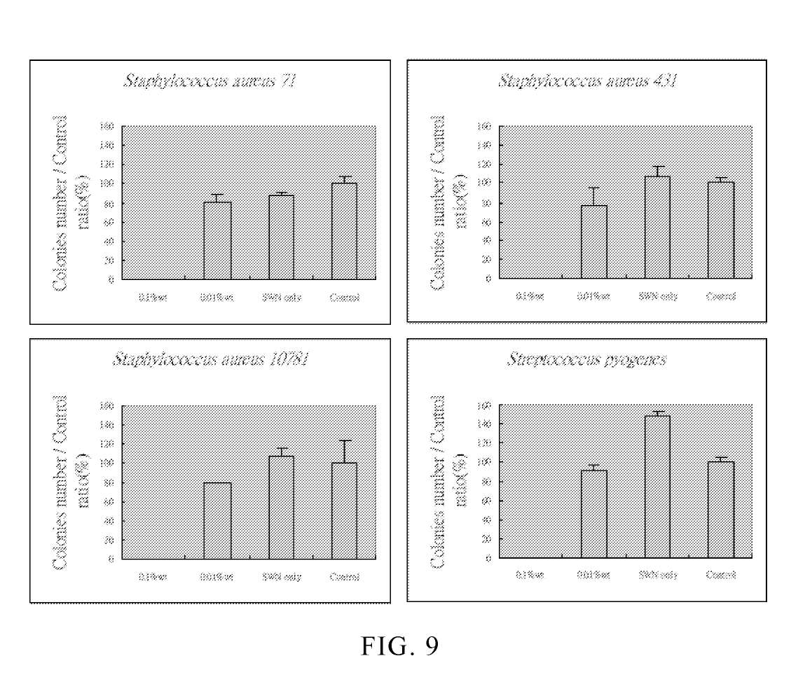

As shown in FIG. 9, the y-axis indicates the growth percentage of the colonies relative to the control groups (100%), since the numbers of the growing colonies were quite different for different bacteria. The composite of AgNP/SWN (0.1 wt %) showed good effects in inhibiting both bacteria, and the composite of AgNP/SWN (0.01 wt %) was similar to SWN only and the control groups.

1.2 AgNP/NSP (Staphylococcus aureus 71, Streptococcus pyogenes)

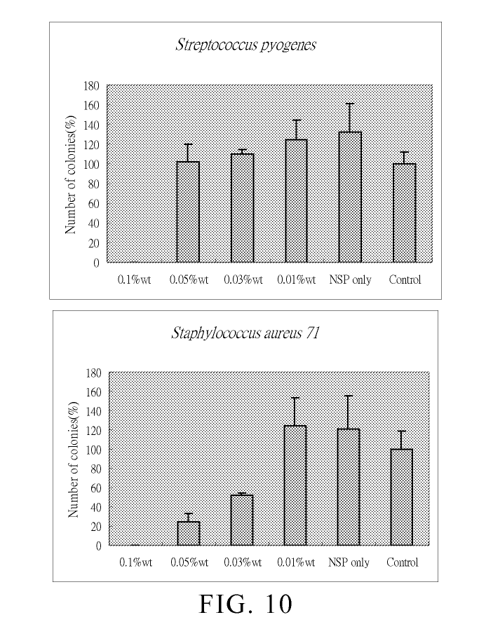

As shown in FIG. 10, the composite of AgNP/NSP (0.1 wt %) performed the best in inhibiting both bacteria. The composites of AgNP/NSP (0.05 wt %) and AgNP/NSP (0.03 wt %) showed lower effects in inhibiting staphylococcus aureus than AgNP/NSP (0.1 wt %). The composite of AgNP/NSP (0.01 wt %) was similar to the NSP only and the control groups.

### 2. Gram Negative Bacteria

2.1 AgNP/SWN (E. coli, Pseudomonas Aeruginosa, Salmonella 4653, 4650, Acinetobacter baumannii)

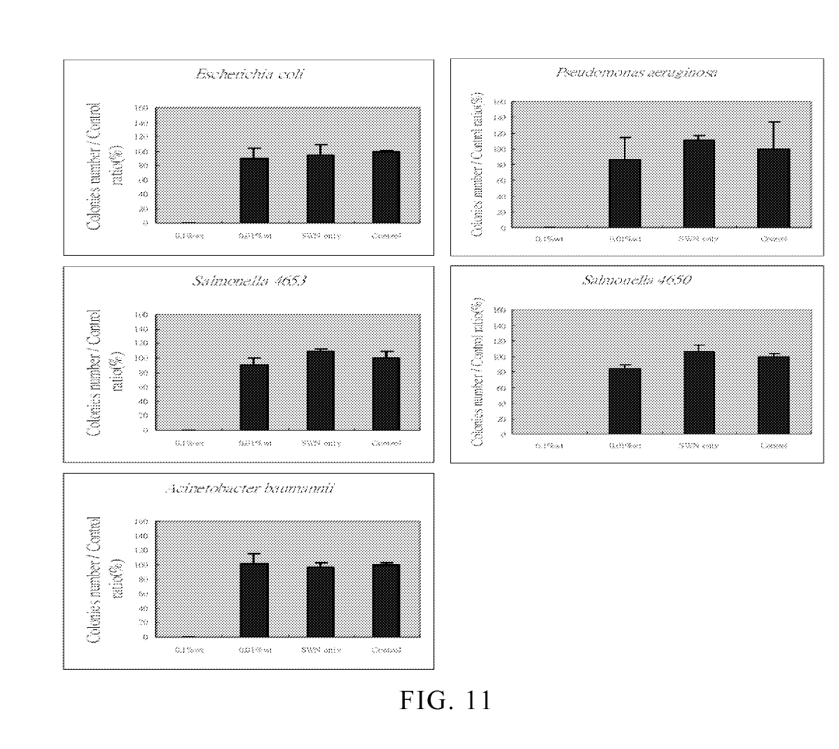

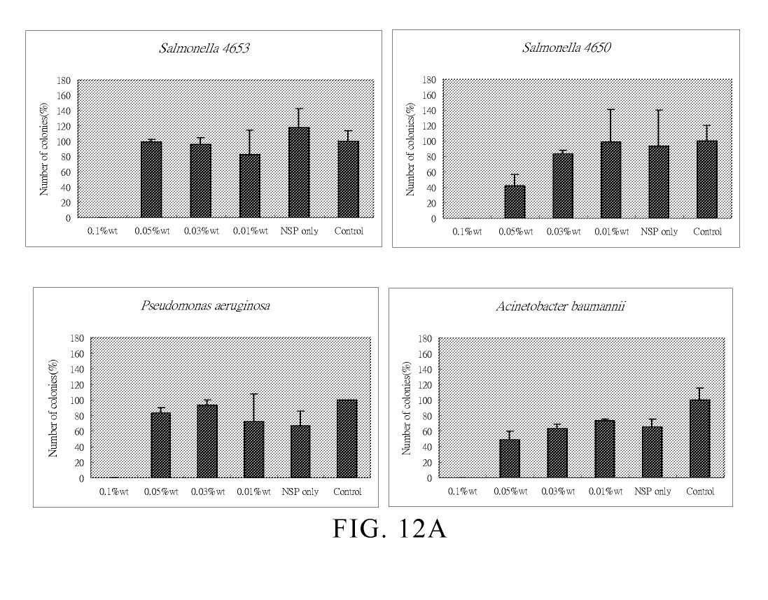

As shown in FIG. 11, the composite of AgNP/SWN (0.1 wt %) performed the best in inhibiting the bacteria, but the composite of AgNP/SWN (0.01 wt %) was similar to the SWN only and the control groups.

2.2 AgNP/NSP (E. coli, Pseudomonas aeruginosa, salmonella 4653, 4650, Acinetobacter baumannii)

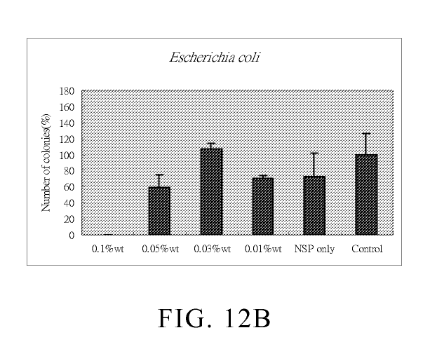

As shown in FIG. 12, the composite of AgNP/NSP (0.1 wt %) performed the best in inhibiting the bacteria, but the composites of AgNP/NSP (0.05 wt %), AgNP/NSP (0.03 wt %) and AgNP/NSP (0.01 wt %) were similar to the NSP only and the control groups.

B. Inhibition of Growth of Multiple Drug Resistant Staphylococcus aureus

The tests were carried out as in A above, and the results were as follows:

### 1. AgNP/SWN

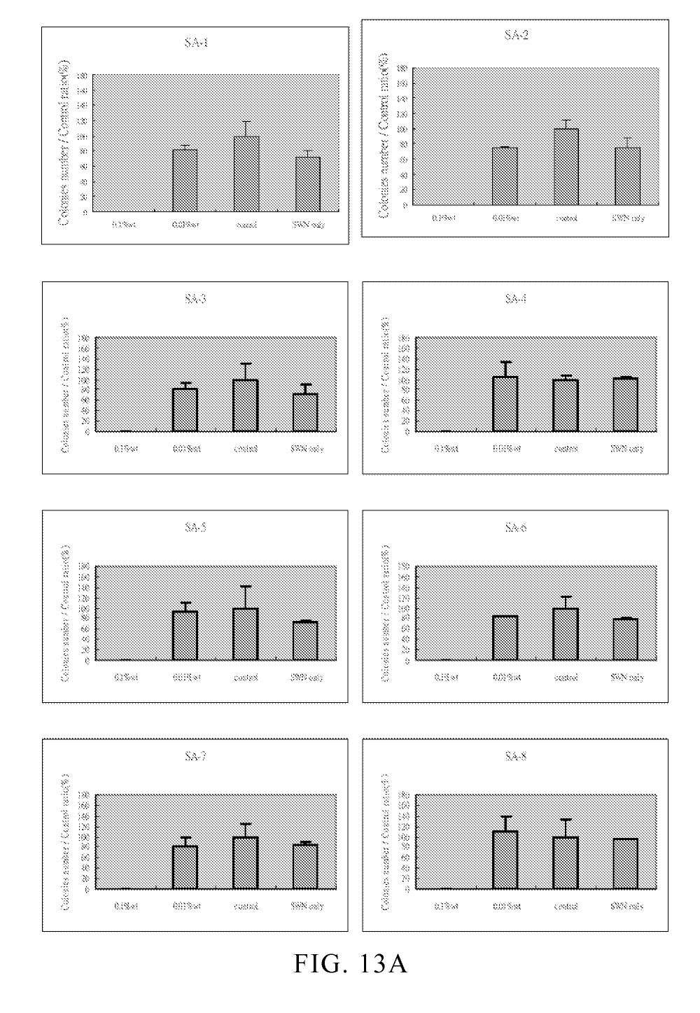

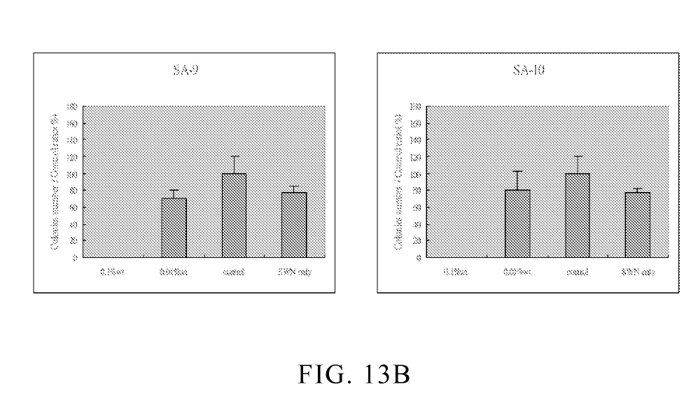

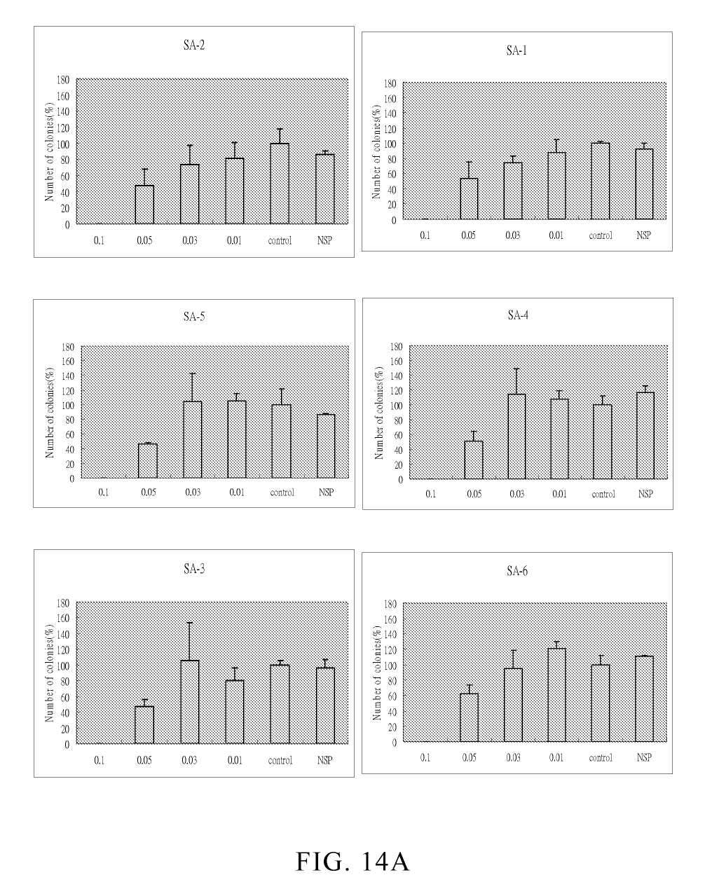

As shown in FIG. 13, the composite of AgNP/SWN (0.1 wt %) performed the best in inhibiting the bacteria, but the composite of AgNP/SWN (0.01 wt %) was similar to the SWN only and the control groups.

### 2. AgNP/NSP

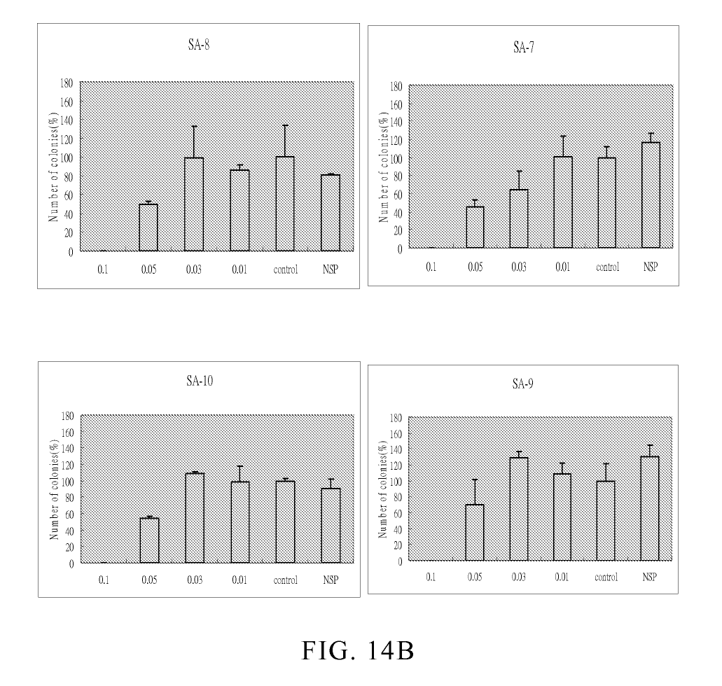

As shown in FIG. 14, the composite of AgNP/SWN (0.1 wt %) performed the best in inhibiting the bacteria, the composite of AgNP/NSP (0.05 wt %) was less, and the composites of AgNP/SWN (0.03 wt % and 0.01 wt %) were similar to the NSP only and the control groups.

### C. Inhibition of Growth of Bacteria in Liquid Media

In this test, the LB liquid media were divided into six groups respectively including the composites of AgNP/NSP (or AgNP/SWN) of different concentrations, only NSP (or SWN), Silvazine (serving as the positive control experiment) and the control group containing no drug, and each LB liquid media after mixing with the drug had a volume of 1 ml. For each group, the standard suspension of bacteria (10 μl) was added therein for culturing at 37° C., and then 10 μl of the suspensions was sampled at the 0th, 0.5th, 1st, 2nd, 4th, 12th, 24th hours and spread on LB solid media (60 mm) for culturing at 37° C. for 16 hours. Numbers of the colonies at each time point was counted. Results were as follows:

1. Gram Positive Bacteria (Staphylococcus aureus)

### 1.1 AgNP/SWN

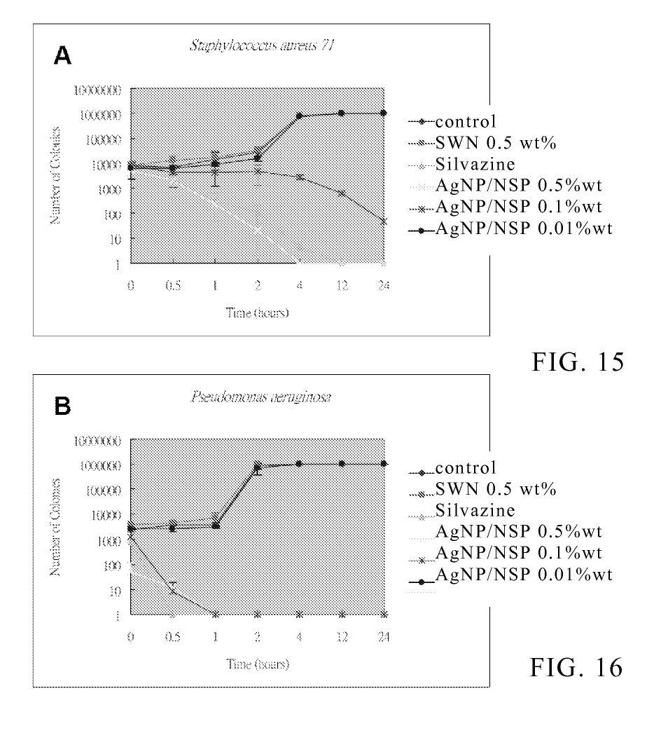

The x-axis indicated time and the y-axis indicated numbers of the growing colonies. As shown in FIG. 15, Silvazine including equivalent content of silver to AgNP/SWN (0.5% wt) did not perform as well as the composite of AgNP/SWN (0.5 wt %). The composite of AgNP/SWN (0.1 wt %) did not perform as well as the composite of AgNP/SWN (0.5 wt %). The results from the composites of AgNP/SWN (0.01 wt %), SWN (0.5 wt %), the positive control group containing Silvazine and the control containing no drug were similar.

### 1.2 AgNP/NSP

As shown in FIG. 16, Silvazine including equivalent content of silver to AgNP/NSP (0.5 wt %) did not perform as well as the composite of AgNP/NSP (0.5 wt %). The composite of AgNP/NSP (0.1 wt %) did not perform as well as the composite of AgNP/NSP (0.5 wt %). The results from the composites of AgNP/NSP (0.01 wt %), NSP (0.5 wt %), the positive econtrol group containing Silvazine and the control containing no drug were similar.

2. Gram Negative Bacteria (Pseudomonas aeruginosa)

### 2.1 AgNP/NSP

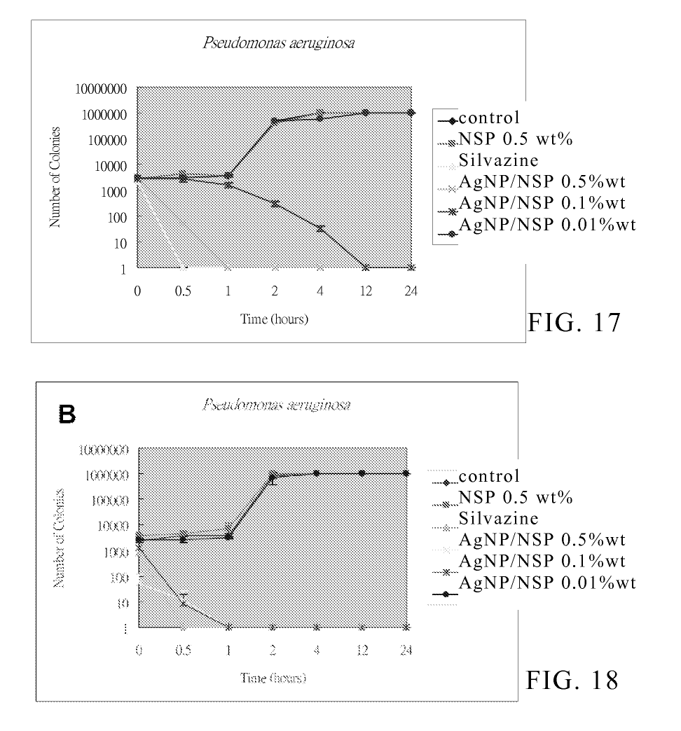

As shown in FIG. 17, the composite of AgNP/NSP (0.5 wt %) still performed better than Silvazine. Though the composite of AgNP/NSP (0.1 wt %) did not perform as well as Silvazine and AgNP/NSP (0.5 wt %), good results were achieved after twelve hours. The composites of AgNP/NSP (0.01 wt %), NSP (0.5 wt %) and the control containing no drug were similar.

### 2.2 AgNP/SWN

As shown in FIG. 18, the composite of AgNP/SWN (0.5 wt %), AgNP/SWN (0.1 wt %) and Silvazine all performed well after one hour though there were slight differences in the results. The composites of AgNP/SWN (0.01 wt %), SWN (0.5 wt %) and the control containing no drug were similar.

### D. Inhibition of Spore Germination of Fungi by AgNP/NSP

### 1. Liquid Media

The suspensions of spores of aspergillus were mixed with the composites of AgNP/NSP of different concentrations and placed in PDB media for culturing at 28° C. for 16 hours.

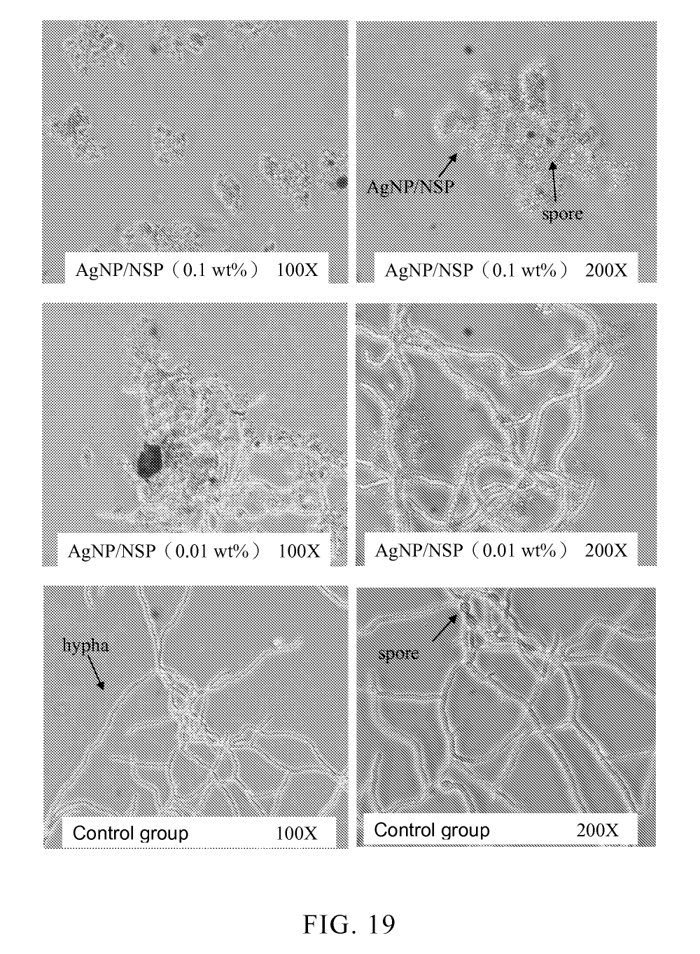

Results were shown in FIG. 19, no filament was found in the media containing AgNP/NSP (0.1 wt %) and almost no spores were found, which indicated that most of the spores were combined with the composite of AgNP/NSP. In the medium containing AgNP/NSP (0.01 wt %), some filaments were observed and the composite of AgNP/NSP was apparently adsorbed around the filaments. For the control group, a lot of filaments were observed. In this figure, the bulks and the objects adsorbed on the surfaces of the filaments were AgNP/NSP.

### 2. Solid Media

The suspensions of spores of penicillium, trichoderma HA, fusarium, cladosporium and aspergillus were prepared and each was spread on four PDA solid media respectively including AgNP/NSP (0.1 wt %), AgNP/NSP (0.01 wt %), NSP (0.1 wt %) and none (the control group) for culturing for about 48 hours. No nutrient was added into these media.

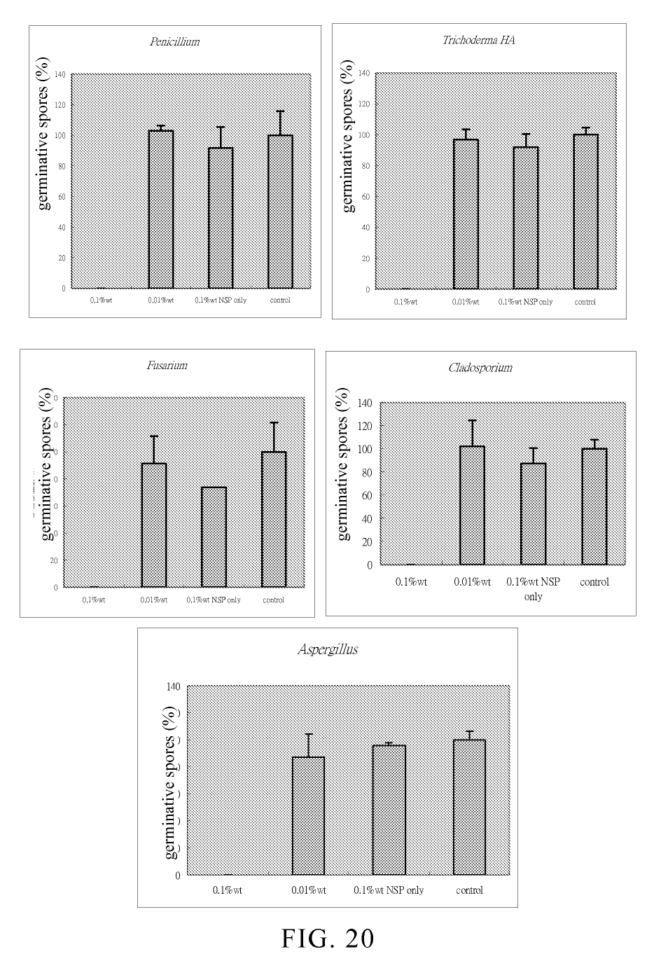

As a result, no filament was found in the medium containing AgNP/NSP (0.1 wt %), and some filaments were observed in the other three. Percentages of the geminative spores of these five fungi were shown in FIG. 20.

### E. Inhibition of Growth of Bacteria by AgNP/SWN of Different Ratios

The composites of AgNP/SWN obtained in Example 20 (Ag⁺/CEC=0.2/1.0), Example 21 (Ag⁺/CEC=1.0/1.0) and Example 22 (Ag⁺/CEC=2.0/1.0) were selected and each was prepared at the concentrations 0.1 wt %, 0.05 wt % and 0.01 wt %. These suspensions were then added into LB solid media so as to compare inhibition effects of the composites with different contents of clay.

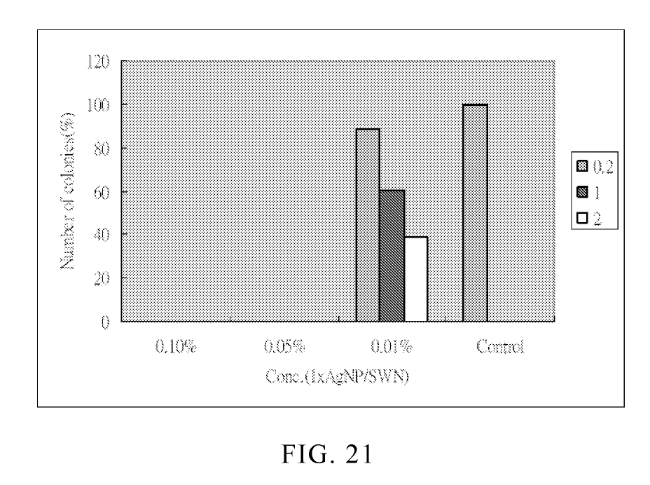

As shown in FIG. 21, the composites of AgNP/SWN having different contents of clay performed well at concentrations of 0.1 wt % and 0.05 wt %. For the composite of AgNP/SWN (0.01 wt %), the effect improved with the ratio of Ag⁺/CEC. That is, too much clay could result in the growth of bacteria.

### F. Burns on Bare Mice

A metal scalpel was heated on an iron plate (set to 95° C.) and then attached to the backs of the bare mice for 30 seconds. The burned epidermis became transparent and were removed to expose dermis. The suspension (100 μl) of staphylococcus aureus having OD₆₀₀ value between 0.4-0.6 was dropped on the burned skins except that of the control group. The mice were divided into six groups and applied the drugs as indicated in Table 3. The wounds were swathed with Tegaderm dressing of 3M. After 24 hours, the wounds were observed and results were listed in Table 3.

TABLE 3

| | | Dosage, | |
|---|---|---|---|
| Group | Medicine | concentration | Result |
| 1 | AgNP/NSP | 100 μl, 1 wt % | No inflammation |
| 2 | AgNP/SWN | 100 μl, 1 wt % | No inflammation |
| 3 | silver sulfadiazine | 100 μl, 0.19 wt % | No inflammation |
| | (Silvazine) | | |
| 4 | NSP | 100 μl | Obvious inflammation |
| 5 | only the suspension | | Obvious inflammation |
| | of bacteria | | |
| 6 | No suspension | | No inflammation |
| | of bacteria | | |
| | and medicine | | |

As shown in Table 3, no inflammation occurred on the wound without adding bacteria and medicine, and obvious inflammation was observed on the wound of the negative control group having bacteria added. That is, this test was not influenced by bacteria in the environment. The composites of AgNP/NSP and AgNP/SWN of this invention performed well as the commercialized silver sulfadiazine (Silvazine). Only NSP without AgNP was not effective on inhibiting the growth of bacteria.

In summary, the composite of AgNP and inorganic clay of the present invention exhibits the following characteristics:
1. The clay can be provided as carriers to adsorb AgNP and thus creates steric barrier hindering AgNP from entering the cells and destroying them.
2. The composites of AgNP/SWN (0.1 wt %) and AgNP/NSP (0.1 wt %) cultured in solid media can effectively inhibit the growth of 99% or more colonies and also inhibit spore germination of fungi.
3. The composites can be mixed with proper solvents or carriers to give stable water-soluble composites which are suitable for use as a common antibacterial sprayer and for treatment of burns or scalds.

In addition, the composite of AgNP and inorganic clay of the present invention can be in the form of solid by removing the solvent (i.e., solid content is 100 wt %) and the AgNP will not coagulate. Therefore, the product is suitable for delivery and manufacturing and stable for long time. For example, the composite can remain in golden color without coagulation and oxidation after one half year.

In the present invention, water is used to minimize the problems of organic solvents. Another advantage is that the clay can be easily obtained from natural sources, and the entire procedures are environmentally benign.

Though the bentonite clay (CEC=0.67 mequiv/g) is selected in the preferred embodiments of the present invention, other kinds of clay can be used, for example, montmorillonite, synthetic mica, talc, etc. Though these kinds of clay have different ionic characters or CECs, aspect ratios, specific surface areas, charge densities and steric structures, they are suitable for producing Ag nanoparticles. Essentially, ionic exchanging and reduction process are influenced by the kinds of the clays or the properties of ions between layers of clay, valence, static electricity, distribution between layers of clay and density and amount of the charges.

In the present invention, the reducing agents are not limited to methanol and NaBH₄, and can be selected from the group of alcohols including ethanol, propanol, butanol, ethylene glycol, glycerol and other alcohols. Different reducing agents may affect the nanoparticle sizes and the yield of the products.

In the present invention, the metal ions are not limited to silver ions, and can be ions of Au, Cu, Fe or other appropriate metals. In addition to silver nitrate, the silver ions can be provided from AgBrO₃, AgBr, AgClO₃, AgCl, or any other appropriate silver compounds.

Compared to the traditional processes, the method of the present invention is simple and cost effective in process, equipment and operation. Further, the layered clays with high aspect ratio (such as 750 m²/g) and high charge density (such as 1 ion/nm²) are more beneficial for the production of finely dispersed nanoparticles.

What is claimed is:

1. A composite of metal nanoparticles and inorganic clay, comprising metal particles and inorganic layered clays, wherein the inorganic layered clays have an aspect ratio of 10-100,000 and serve as an inorganic dispersant or carrier in the amount of 1:100 to 100:1 weight ratio to the metal particles, whereby the metal particles are capable of being dispersed on a nanoscale into metal nanoparticles in aqueous solution.

2. The composite of metal nanoparticles and inorganic clay as claimed in claim 1, wherein the metal particles have a spherical structure.

3. The composite of metal nanoparticles and inorganic clay as claimed in claim 1, wherein the metal particles are Au, Ag, Cu or Fe.

4. The composite of metal nanoparticles and inorganic clay as claimed in claim 1, wherein the metal particles are Ag.

5. The composite of metal nanoparticles and inorganic clay as claimed in claim 1, wherein the inorganic layered clay has an aspect ratio of 100-1,000.

6. The composite of metal nanoparticles and inorganic clay as claimed in claim 1, wherein the inorganic layered clay is bentonite, laponite, montmorillonite, synthetic mica, kaolin, talc, attapulgite clay, vermiculite or double hydroxide (LDH).

7. The composite of metal nanoparticles and inorganic clay as claimed in claim 1, wherein the inorganic layered clay has a structure with a ratio of Si-tetrahedron:Al-octahedron of 1.5:1-2.5:1 as smectite natural clay.

8. The composite of metal nanoparticles and inorganic clay as claimed in claim 1, wherein the inorganic layered clay has a cation exchange capacity (CEC) of 0.1-5.0 mequiv/g.

9. The composite of metal nanoparticles and inorganic clay as claimed in claim 1, wherein the ratio of the ionic equivalent of the metal particles to the cation exchange equivalent of the inorganic layered clay is 0.1-200.

10. The composite of metal nanoparticles and inorganic clay as claimed in claim 1, wherein the weight ratio of the metal nanoparticles to the inorganic layered clay ranges from 1:30 to 30:1.

11. The composite of metal nanoparticles and inorganic clay as claimed in claim 1, which is used as an antibacterial.

12. The composite of metal nanoparticles and inorganic clay as claimed in claim 11, which is used to inhibit growth of Gram positive bacteria, Gram negative bacteria or fungi.

13. The composite of metal nanoparticles and inorganic clay as claimed in claim 11, which is used to inhibit growth of staphylococcus aureus, streptococcus pyogenes, pseudomonas aeruginosa, salmonella, E. coli, acinetobacter baumannii, multiple drug resistant staphylococcus aureus or fungi.

14. The composite of metal nanoparticles and inorganic clay as claimed in claim 11, which is in a powder form.

15. An antibacterial, comprising a therapeutic dosage of the composite of metal nanoparticles and inorganic clay as claimed in claim 10 and a solvent or a carrier other than the inorganic layered clay.

16. The antibacterial as claimed in claim 15, wherein the solvent is water.

17. The antibacterial as claimed in claim 15, wherein the antibacterial composite of metal nanoparticles and inorganic clay has a solid content of 0.01 wt % or higher.

18. The antibacterial as claimed in claim 15, which has a solid content 0.05-100 wt % when used to inhibit Gram positive bacteria, or a solid content 0.01-100 wt % when used to inhibit Gram negative bacteria or multiple drug resistant staphylococcus aureus.

19. A method for producing a stably-dispersed composite of metal nanoparticles and inorganic clay, comprising a step of mixing a metal ionic compound, inorganic layered clay and a reducing agent in water to perform a reductive reaction, wherein the inorganic layered clay has an aspect ratio of 10-100,000 and serves as a dispersant or protector of the metal, so that the metal ionic compound is reduced to metal particles dispersed on a nanoscale.

20. The method as claimed in claim 19, wherein the metal is Ag, Au, Cu or Fe.

21. The method as claimed in claim 19, wherein the metal is Ag.

22. The method as claimed in claim 19, wherein the metal ionic compound is AgNO₃, AgCl, AgBr, AuBr₃, AuCl or HAuCl₄.3H₂O.

23. The method as claimed in claim 19, wherein the inorganic layered clay has an aspect ratio of 100-1,000.

24. The method as claimed in claim 19, wherein the inorganic layered clay is bentonite, laponite, montmorillonite, synthetic mica, kaolin, talc, attapulgite clay, vermiculite or LDH.

25. The method as claimed in claim 19, wherein the inorganic layered clay has a ratio of Si-tetrahedron:Al-octahedron of 1.5:1-2.5:1.

26. The method as claimed in claim 19, wherein the inorganic layered clay has a cation exchange capacity (CEC) of 0.1-5.0 mequiv/g.

27. The method as claimed in claim 19, wherein the ratio of the ionic equivalent of the metal particles to the cation exchange equivalent of the inorganic layered clay is 0.1-200.

28. The method as claimed in claim 19, wherein the reducing agent is methanol, ethanol, propanol, butanol, formaldehyde, ethylene glycol, propylene glycol, butylene glycol, glycerin, poly(vinyl alcohol), poly(ethylene glycol), PPG (polypropylene glycol), dodecanol or sodium borohydride (NaBH₄).

29. The method as claimed in claim 19, wherein the reduction reaction is performed at 25-150° C. for 0.01-20 hours.

30. The method as claimed in claim 19, wherein the reduction reaction is performed with lighting of a xenon lamp.

31. The method as claimed in claim 19, further comprising a step of drying the product of the reductive reaction after the reduction reaction so as to obtain a powder product.

32. The method as claimed in claim 19, wherein the composite of metal nanoparticles and inorganic clay is used as an antibacterial.

33. The method as claimed in claim 32, wherein the weight ratio of the metal nanoparticles to the inorganic layered clay ranges from 1:100 to 100:1.

34. The method as claimed in claim 32, wherein the reducing reaction is carried out with sonic blending.

35. The method as claimed in claim 32, wherein the antibacterial composite of metal nanoparticles and inorganic clay is used to inhibit growth of Gram positive bacteria, Gram negative bacteria or fungi.

36. The method as claimed in claim 32, wherein the antibacterial composite of metal nanoparticles and inorganic clay is used to inhibit growth of staphylococcus aureus, streptococcus pyogenes, pseudomonas aeruginosa, salmonella, E. coli, acinetobacter baumannii, multiple drug resistant staphylococcus aureus or fungi.
